(19) United States
(12) Patent Application Publication
(10) Pub. No.: US 2015/0331567 A1
(43) Pub. Date: Nov. 19, 2015

(54) INTERACTION/RESOURCE NETWORK DATA MANAGEMENT PLATFORM

(71) Applicant: SageLife Innovations, LLC, Horsham, PA (US)

(72) Inventor: Glenna M. Crooks, Philadelphia, PA (US)

(73) Assignee: SageLife Innovations, LLC, Horsham, PA (US)

(21) Appl. No.: 14/278,826

(22) Filed: May 15, 2014

(51) Int. Cl. G06F 3/0484

(52) U.S. Cl. CPC G06F 3/0484

(57) ABSTRACT

A computer-implemented interactive system and methods are herein disclosed that allow for the interactive aggregation, navigation/management, and communication of interaction/resource network (e.g., relationships, resources and social connections). An exemplary server computer environment is operable to communicate and cooperate with other computing environments to receive, process, and store data representative of a person's interactions and/or resource network elements. The exemplary server computing environment executes one or more instruction sets (e.g., interaction/resource network management engine) to process received data representative of an interaction and/or resource network elements according to a selected interaction/resource network data management methodology (e.g. expressed as web based computing application). The received data can be inputted using an interactive graphical user interface that allows for the creation of one or more interaction/resource network element maps. Server computing environment can further comprise one or more data stores for the storage and retrieval of interaction/resource network data and other associated data.

### BACKGROUND

Current time management and productivity improvement methods focus on tasks. They promote listing and prioritizing activities. Those approaches ignore that associated with every task is a person and that the people involved—be they episodic encounters or ongoing/continuing interactions (e.g., personal/business/pet relationships, connections, friendships, family, and others resources like physicians, contractors or a child's teacher, etc.) will—in large part—determine the outcome of the activity. The people involved can be important assets or may create serious liabilities. Pundits postulate that positive ways of relating with others—whether episodically or on an ongoing/continuing basis—are the key to success in business. The same can be said for personal success and satisfaction in personal life. Limbic brain satisfaction derives from satisfying interactions with others and without them—even when physical needs are provided—humans can die. The “bandwidth” to handle and manage ongoing/continuing interactions is not boundless, however. Evolutionary psychologists postulate that an individual can successfully manage one-hundred fifty (150) ongoing different interactions at a given time in a person's life. A healthy, energetic, well-organized person armed with the latest in scheduling and communication tools, technologies, and services (e.g., personal digital assistant, smartphone, tablet, email, texting, social media, etc.) can likely manage more interactions than the average but, the number is not unlimited. Few people take account of the number of people they manage. Single woman homeowners, would be surprised to know they manage between forty five and fifty (45-50) relationships in support of basic life-and-home maintenance needs (i.e., keeping herself and her home going). Add a spouse/life partner, children, a pet, elderly parents who need support or her own illness, and this same woman may only have fifty (50) slots left over for ongoing/continuing interactions at work.

Personal relationship networks (e.g., relationship and resource networks) can be problematic and difficult to navigate. They—and the tools used to manage them—are often complex, fragmented and in disarray. Further, no robust tools are available to help people gain insight into how to identify, assess and proactively manage them. Personal and career-life relationship and resource network “bandwidth” is stretched to the breaking point far too often. The personal networks required to achieve happier, healthier, more successful and satisfied lives, if mismanaged, can have dire personal, family and workplace consequences.

Today's 24/7/365 “always on” world—recently referred to as “evertime” presents everyone with increasing demands for attention from family, friends, co-workers and strangers alike. Additionally, those in the workforce are being asked to do “more with less.” This started during economic downturns but is now becoming the “new norm.” These factors complicate interaction/resource/relationship network navigation/management tasks while simultaneously weakening the support fiber humans need for success, satisfaction and ease in so many aspects of their lives. The failure to manage interactions within personal relationship and resource networks has negative consequences and interferes with success, satisfaction and happiness. Unskillful navigation/management—including the failure to limit the network to a manageable size—decreases productivity and increases emotional stress and turmoil. It negatively impacts family and career performance, and adversely effects health and economic success.

Tools are available to manage personal-life networks, but they are not fully helpful. Social media (e.g., Facebook, MySpace, and Twitter) name and collect individuals within a social network. This facilitates efficient communication with those involved, but communication is only one aspect of navigation/management. Even the communication value is negated when some important people in within a personal network do not routinely use social media sites. By way of example, some Grandparents, routinely miss—or learn only far later—their grandchildren's milestones because those milestones are posted only on social media services (e.g., Facebook), a platform the Grandparent does not use frequently. Further, current social media services promote quantity of contacts, encouraging its users to “friend” each other, leading some users to compete with others for a quantity of “friends”, to the detriment of building quality, mutually supportive interactions with others.

Other currently available personal network management tools focus on a person's professional-life interactions/relationships. For example, LinkedIn collects and segments relationships, allowing for criteria-based searches and communications. Customer Relationship Management (CRM) software applications and services provide tools for organizing external prospects and customers, in data-centric sales-driven ways. However, LinkedIn does not allow users to codify other, more qualitative, aspects of user's contacts and CRMs are limited to external sales contacts, ignoring internal-company contacts altogether. Specifically, these tools do not allow for a person to manage or enhance the purpose and value (except for sales value) of the relationship/interaction/resource network element. Furthermore, LinkedIn does not encourage, and CRMs generally fail, to address key internal company relationship networks. Both fail to address personal-life networks.

Moreover, currently available relationship/interaction management tools and services do not afford users the ability, beyond aggregation and possibly classification (e.g., family group, work group, church group, etc.) to quantitatively and qualitatively rank, rate, and describe the quality of a given interaction/relationship/resource network element. Without this substantially important metric, users are often left on their own to identify which of the hundreds and hundreds of stored interactions/relationships/resource network elements are of specific importance at any given time point. Currently available tools are little more than contact directories than actual tools to assist a user to effectively navigate/manage their interaction/relationship/resource network element. Additionally, existing practices, tools, and service are deficient in providing contextual information about a person's interaction/resource network that can be used by a user to more effectively navigate/manage such interactions/resource network. By way of example, existing tools/services may offer specific recommendations to a user to add new connections to their personal relationship and resource network based on some demographic commonalities (e.g., attended the same school, work at the same company, attend the same church) however, such tools/services do not provide assistance about how to better navigate/manage a person's existing network of interactions/relationships/resource network (e.g., through research-based evidence, articles, blogs, professional service referrals) based on the network elements and how the user ranks/rates such interactions/relationships/resource network elements.

From the foregoing, it is appreciated that there exists a need for systems and methods that are aimed to ameliorate the shortcomings of existing practices.

### SUMMARY

A computer-implemented interactive system and methods are herein disclosed that allow for the interactive aggregation, navigation/management, and communication of interaction/resource network (e.g., relationships, resources and social connections). In an illustrative implementation, the computer-implemented interactive system comprises an exemplary server computer environment operable to communicate and cooperate with other computing environments to receive, process, and store data representative of a person's interactions and/or resource network elements. In the illustrative implementation, the exemplary server computing environment executes one or more instruction sets (e.g., interaction/resource network management engine) to process received data representative of an interaction and/or resource network elements according to a selected interaction/resource network data management methodology. In the illustrative implementation, the received data can be inputted using an interactive graphical user interface (GUI) that allows for the creation of one or more interaction/resource network element maps. Furthermore, server computing environment can further comprise one or more data stores for the storage and retrieval of interaction/resource network data and other associated data comprising interaction/resource network scenario data, interaction/resource network map template data, and interaction/resource network benchmark data.

In an illustrative operation, the exemplary server computing environment cooperates with other computing environments to receive data through the exemplary interactive GUI representative of an interaction and/or resource network element. The data is processed to create an interaction/resource network map that is operable to display various selected characteristics of inputted interactions and/or resource network elements. In the illustrative operation, the interaction/resource network management engine processes the received interaction/resource network data to identify specific interaction and/or resource network data types. Illustratively, based on the inputted types, interaction/resource network management engine is operable to retrieve data representative of one or more interaction scenarios (e.g., additional suggested interaction/resource network elements) for inclusion in the created interaction/resource network map. Further, in the illustrative implementation, interaction/resource network map data is operably scanned by the interaction/resource network engine to identify the presence of selected interaction/resource network elements to retrieve various referral data (e.g., through research-based evidence, articles, blogs, professional service referrals) for communication by exemplary server computing environment to other cooperating computing environments.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features of the herein described systems and methods are further described below.

### BRIEF DESCRIPTION OF THE DRAWINGS

The interactive systems and methods for aggregating, managing, analyzing, and communicating interaction data are described with reference to the accompanying drawings in which:

FIG. 1 is a block diagram of an exemplary computing environment in accordance with an implementation of the herein described systems and methods;

FIG. 2 is a block diagram of an exemplary networked computing environment and the interaction among its components in accordance with an implementation of the herein described systems and methods;

FIG. 3 is a block diagram showing the cooperation of exemplary components of an illustrative implementation in accordance with the herein described systems and methods;

FIG. 4 is a block diagram showing the cooperation of exemplary cooperating parties of an illustrative implementation in accordance with the herein described systems and methods;

FIG. 5 is a flow diagram showing an illustrative method for the aggregation and management of interaction/resource network data in accordance with the herein described systems and methods;

FIG. 6 is a flow diagram showing an illustrative method for the aggregation and management of interaction/resource network data for use by third party professional services providers in accordance with the herein described systems and methods; 3^{rd} party access with user permission

FIG. 7 is a block diagram of an exemplary interaction/resource network data map in accordance with the herein described systems and methods;

FIG. 8 is a block diagram of an exemplary interaction/resource network data map showing an exemplary interaction scenario in accordance with the herein described systems and methods;

FIG. 9 is a flow diagram showing an illustrative method for an exemplary use case of an illustrative interaction/resource network platform in accordance with the herein described systems and methods;

FIGS. 10-12 are block diagram s showing illustrative features of an exemplary user interface operable for communication of data with an illustrative interaction/network data management platform for use in the aggregation and management of interaction/resource network data in accordance with the herein described systems and methods;

FIG. 13 is a flow diagram of an illustrative method for the interaction/network resource data processing and interaction referral data retrieval in accordance with the herein described systems and methods;

FIG. 14 is a flow diagram showing an illustrative method for the rating of various interaction/network resource data in accordance with the herein described systems and methods; and

FIG. 15 is a flow diagram showing an illustrative method for performing benchmarking of various interaction/network resource data in accordance with the herein described systems and methods.

### DETAILED DESCRIPTION OF ILLUSTRATIVE EMBODIMENTS

### Overview:

There are several benefits associated with the identification and navigation/management of one's relationship and resource network elements (e.g., people). For example, it encourages an understanding of a person's total “relationship and resource network management” workload. Most people are generally unaware of the size or nature of that demand on their time and energy. Furthermore, with a proper implementation of interaction/resource network management, one can begin to distinguish between levels and types of relationships, facilitating better decision-making in interpersonal and network engagements. For example, it can help avoid “over-serving” less-important contact, thus preserving time and energy for oneself and/or for more relatively more important interactions/resource network elements.

As is described by the Figures below, the herein described system, methods, and platform provide for the aggregation and management of interaction/resource network (hereafter “I/RN”) data as expressed through a graphical data (e.g., network map) that, operatively and illustratively, provides compelling visual images that are efficient, impactful ways to understand the size, nature, inter-relationships and complexity of one's relationship network. The graphical representation helps a user to quickly assess competing, missing, and time consuming relationships which facilitates better decision-making throughout one's daily experience and results in capturing the scarcity and irreplaceable of commodities—especially, time.

### Illustrative Computing Environment

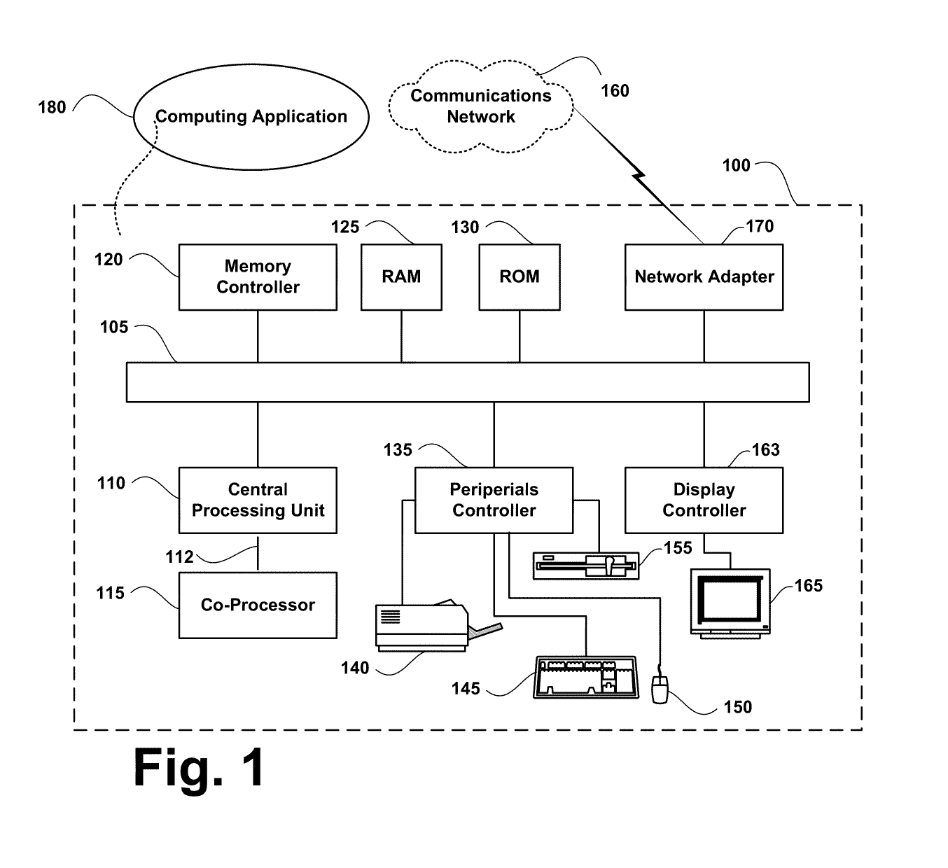

FIG. 1 depicts an exemplary computing system 100 in accordance with herein described system and methods. Examples of computing systems that may be represented by computing system 100 include, but are not limited to, personal computers, server computers, laptop computers, tablet computers, smart phones, and smart phone watches and other wearable computers. The computing system 100 is capable of executing a variety of computing applications 180. Computing application 180 can comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers, a CPU 110 is implemented by micro-electronic chips CPUs called microprocessors. A coprocessor 115 is an optional processor, distinct from the CPU 110 that performs additional functions or assists the CPU 110. The CPU 110 may be connected to coprocessor 115 through interconnect 112. One common type of coprocessor is the floating-point coprocessor, also called a numeric or math coprocessor, which is designed to perform numeric calculations faster and better than the CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, and video. The display controller 163 includes electronic components required to generate a video signal that is sent to display 165. Further, the computing system 100 can contain network adaptor 170 which may be used to connect the computing system 100 to a communications network 160.

### Illustrative Computer Network Environment

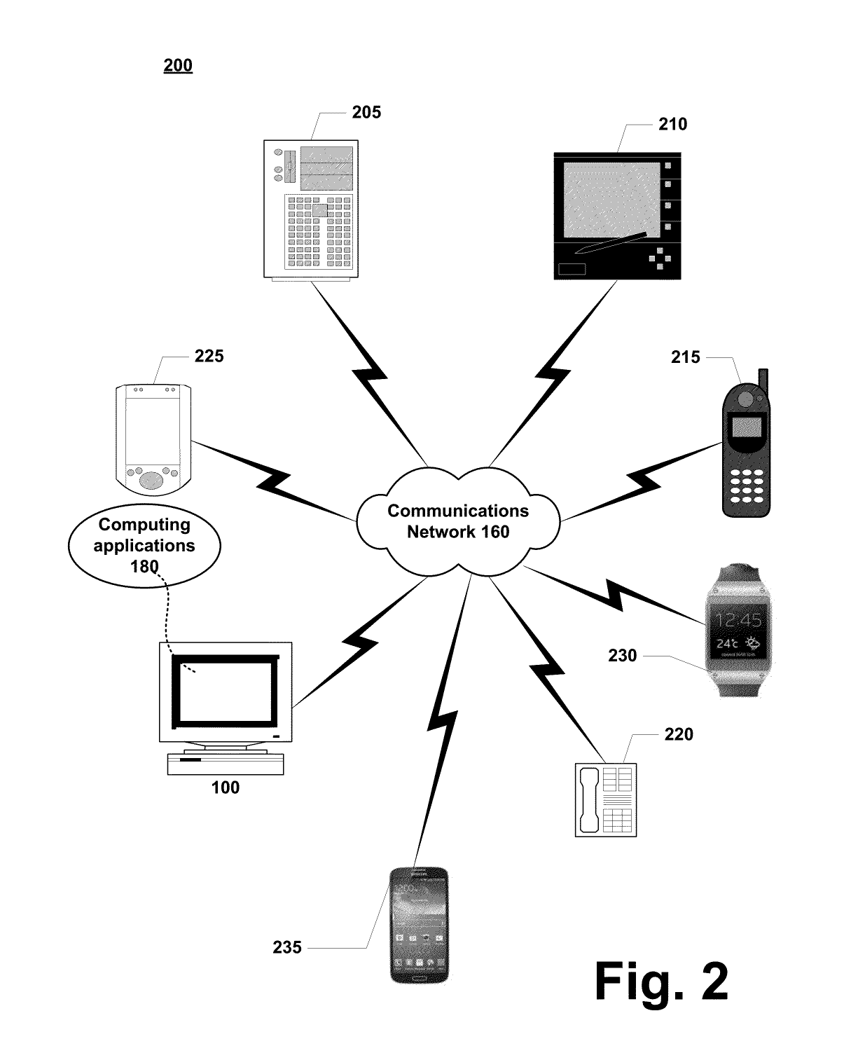

One or more computing systems 100, described above, can be deployed as part of a computer network. In general, the above description for computing environments and computing system 100 applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server computing environment 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments such as tablet personal computer 210, mobile telephone 215, telephone 220, personal computer 202, and personal digital assistant 225, smart phone watch/personal goal tracker (e.g., FitBit) 230, smart phone 235. In a network environment in which the communications network 160 is the Internet, for example, server computing environment 205 can be dedicated computing environment servers operable to process and communicate data to and from client computing environments 100, 210, 215, 220, 225, 230, and 235 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 202, 210, 215, 220, 225, 230, and 235 can be equipped with computing applications 180 such as an operating system operable to support one or more other computing applications, such as a web browser (not shown), or other graphical user interface (not shown), or a mobile desktop environment (not shown) to gain access to server computing environment 205.

Server computing environment 205 may be communicatively coupled other computing environments (not shown) and receive data regarding the participating user's interactions/resource network. In an illustrative operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, 225, 230, and 235, over communications network 160. A participating user may request access to specific data and applications housed in whole or in part on server computing environment 205. These data may be communicated between client computing environments 100, 210, 215, 220, 225, 230, 235 and server computing environment for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

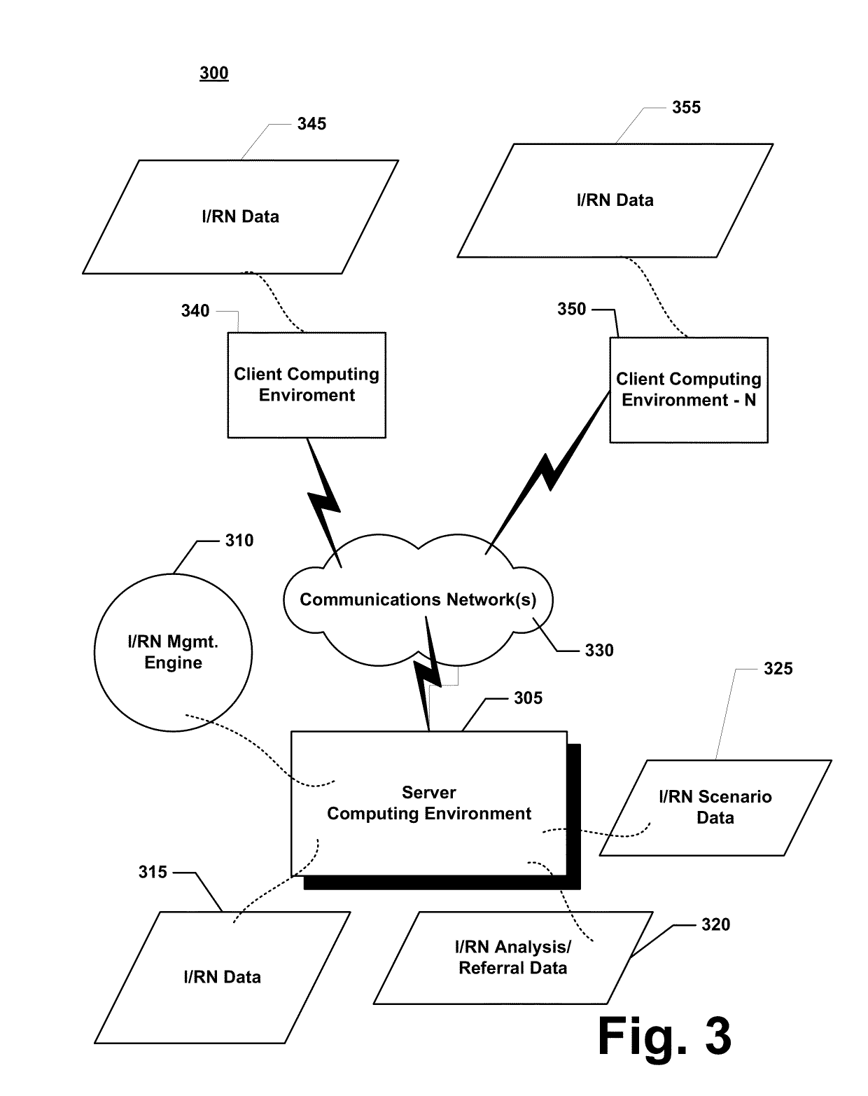

FIG. 3 shows an illustrative implementation of exemplary I/RN data management environment 300. As is shown, exemplary I/RN data management environment 300 comprises server computing environment 305, communications network(s) 330, and client computing environments 340 through 350. Additionally, as is shown, server computing environment 305 is operable to execute URN management engine 310 and store/retrieve data from various data stores including but not limited to URN data store 315, URN analysis/referral data store 320, URN scenario data store 325, and benchmark data store 330. Additionally, client computing environments 340 through 350 are operable to display and provide interactive controls to manipulate, change, and view real time interactive I/RN data 345 and 355.

In an illustrative operation, server computing environment 305 can receive various data inputs representative of one or more interactions/resource network elements from cooperating client computing environments 340 through 350 for storage in I/RN data store 315 and for processing by URN management engine 310 to generate real time interactive URN data 345 and 355 for communication to client computing environments 340 through 350 over communication network(s) 330. In the interest of brevity, only two client computing environments 340,350 are shown in FIG. 3. In should be understood that any number of client computing environments could be associated with the system 300.

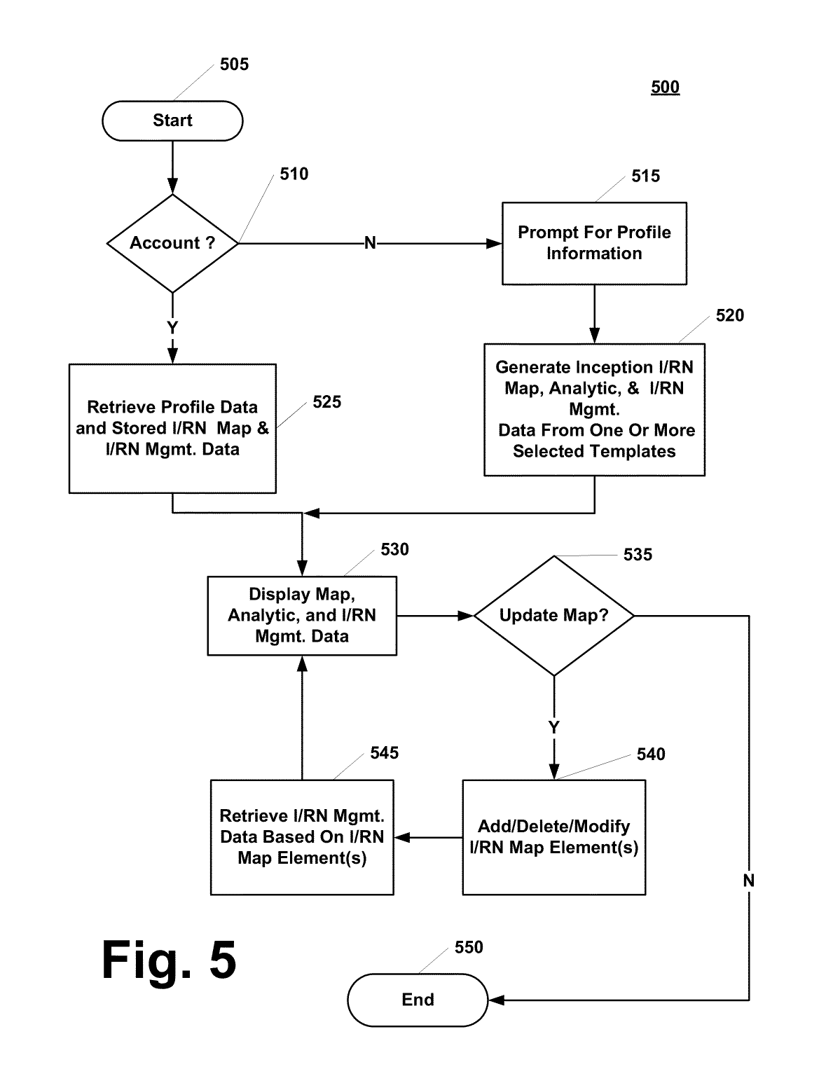

In the illustrative operation, I/RN management engine 310 can process received data inputs according to one or more interaction analytic/referral guidelines that can be retrieved from URN analysis/referral data store 320 to generate I/RN referral data (e.g., according to exemplary method 500 of FIG. 5). Additionally, in the illustrative operation, I/RN management engine 310 can process generated URN referral data (e.g., according to exemplary method 500 of FIG. 5) using one or more I/RN analysis/referral guidelines that can be retrieved from URN analysis/referral data store 320. Further, in the illustrative operation, URN management engine 310 can operatively retrieve for communication to one or more cooperating computing environments 340 through 350, data representative of one or more interaction scenarios and/or intelligent network recommendation data templates from I/RN scenario data store 325 that can be illustratively operatively selected based on the received inputted I/RN data.

In an illustrative implementation, the retrieved interaction scenarios and/or intelligent network element recommendation data template can comprise additional suggested interactions/resource network elements for processing by participating users (not shown)(e.g., if a participating user inputs that s/he is about to have a child as a life change event, a number of suggested relationships can be communicated for the users' consideration including doctor, nutritionist, mid-wife, party planner for a baby shower or in an alternate illustrative implementation, if a participating user inputs data representative of a family but does not include an element to represent a network connection with a estate attorney, the exemplary intelligent network recommendation data template may prompt the participating user with a question regarding the whether the participating user has a prepared any estate planning documents such as a will). Additionally, in the illustrative operation, URN management engine 310 can operatively retrieve for communication to one or more cooperating computing environments 340 through 350, data representative of one or more URN benchmarking data from I/RN benchmarking data store 325 that can illustratively operatively be representative of various benchmarks data as compared with the received inputted I/RN data.

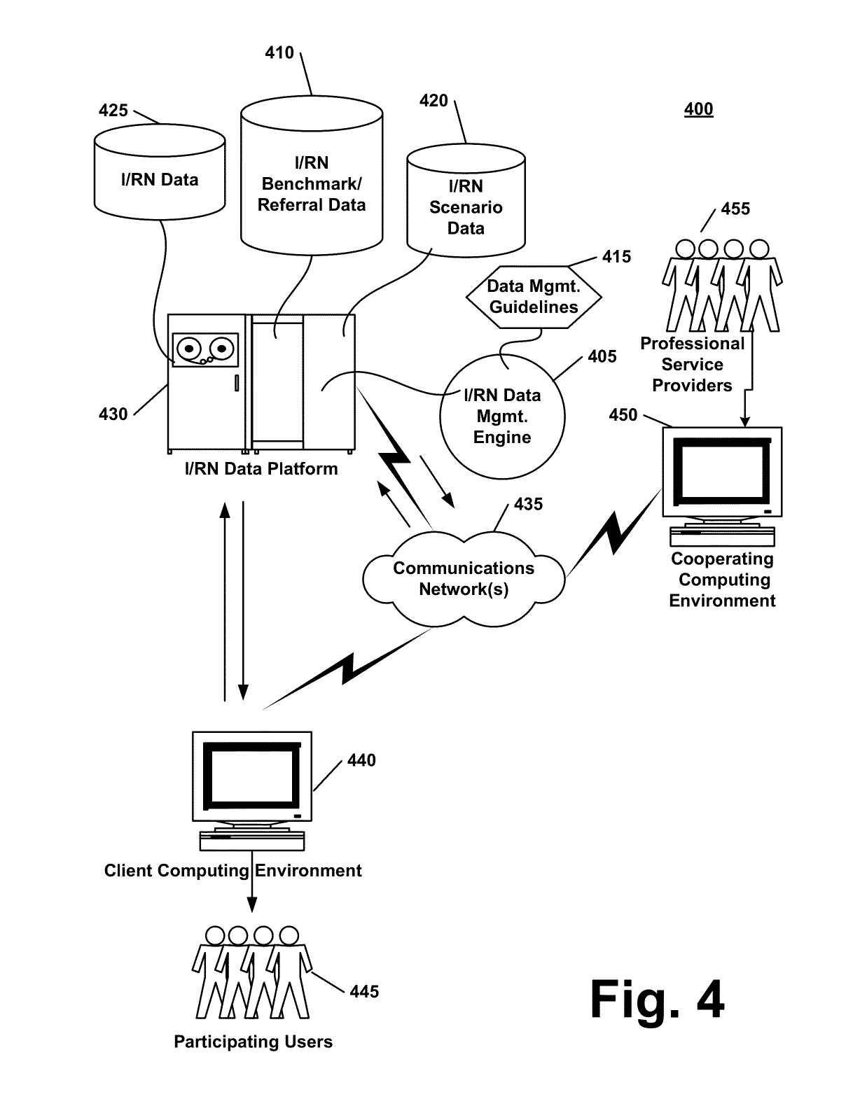

FIG. 4 shows an illustrative implementation of an exemplary I/RN data management environment 400. As is shown, I/RN data management environment 400 comprises I/RN data platform 430, cooperating with a number of data stores, user URN data store 425, I/RN benchmarking/referral data store 410, I/RN scenario data store 420, and executing I/RN data management engine 405 which contains one or more data management guidelines 415. Further, as is shown in FIG. 4, in the illustrative implementation, exemplary I/RN data management environment 400 comprises cooperating computing environments 440 and 450, and communications network 435.

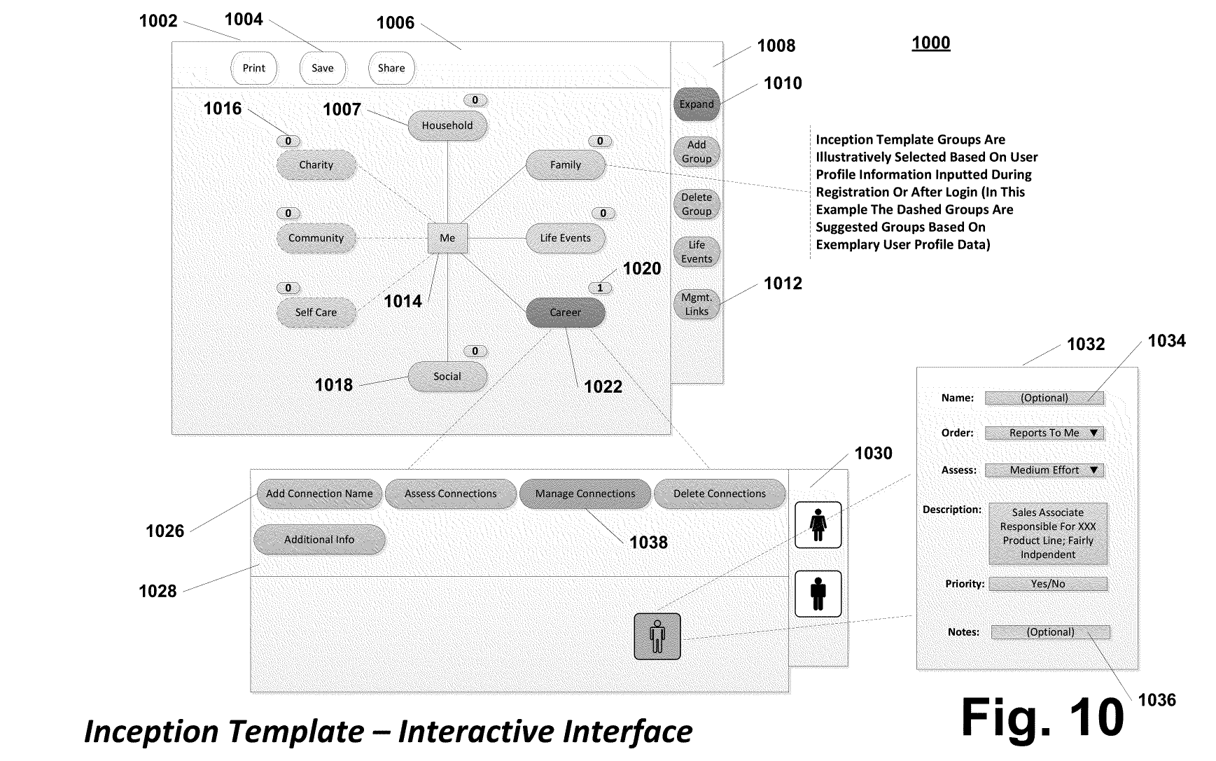

In an illustrative operation, participating users 445 can operatively interact with an interactive computing application (not shown but as described in FIGS. 10, 11, and 12) operable on client computing environment 440 to input data representative of one or more interactions/resource network elements (e.g., present, past, and/or future personal relationships, professional relationships, relationships with pets, relationships with objects, spiritual relationships, social relationships and other resource elements) for communication by client computing environment 440 over communications network 435 to I/RN data platform 430 for processing and storage. Responsive to the received URN data, I/RN data platform 430 can operatively store the received user I/RN data in user URN data store 425. In the illustrative operation, I/RN data management engine 405 can execute on I/RN data platform 430 according to one or more data management guidelines 415 to process the received I/RN data to operatively retrieve I/RN benchmark/referral data from I/RN benchmark/referral data store 410 and/or retrieve I/RN scenario data from I/RN scenario data store 420 for communication back to cooperating client computing environment 440 over communications network 435 to be consumed and digested by participating users 445.

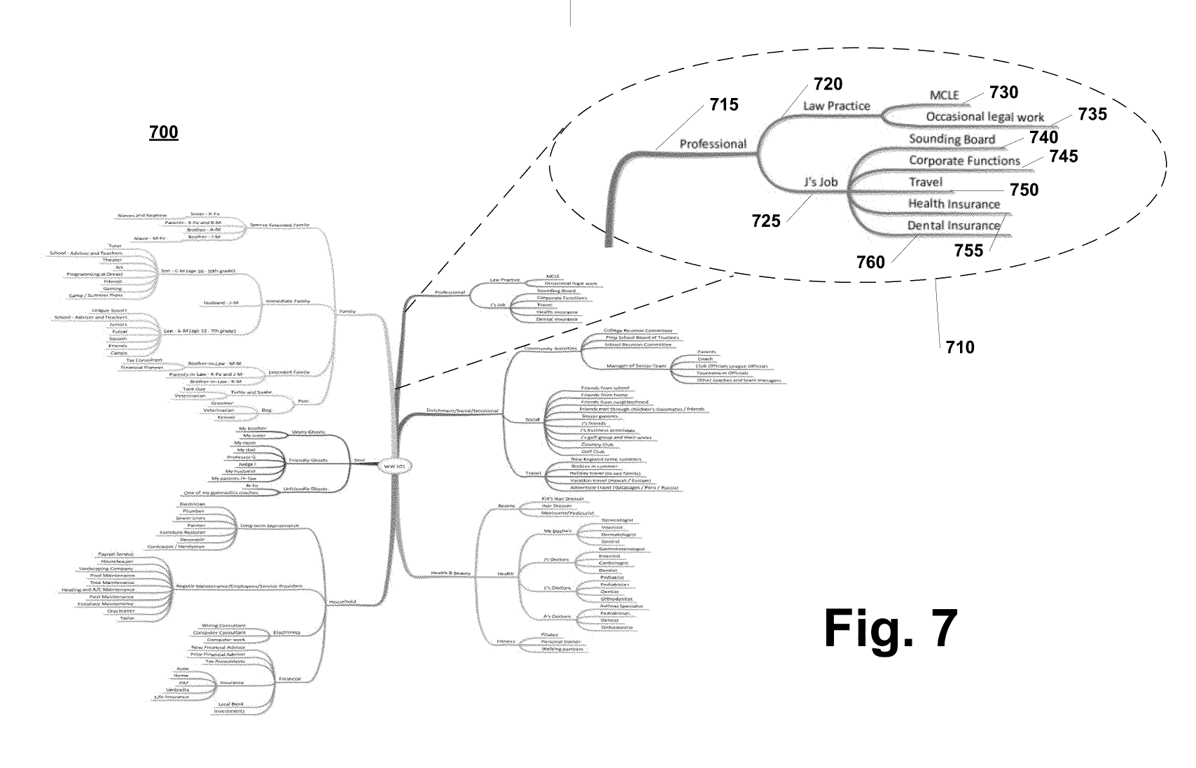

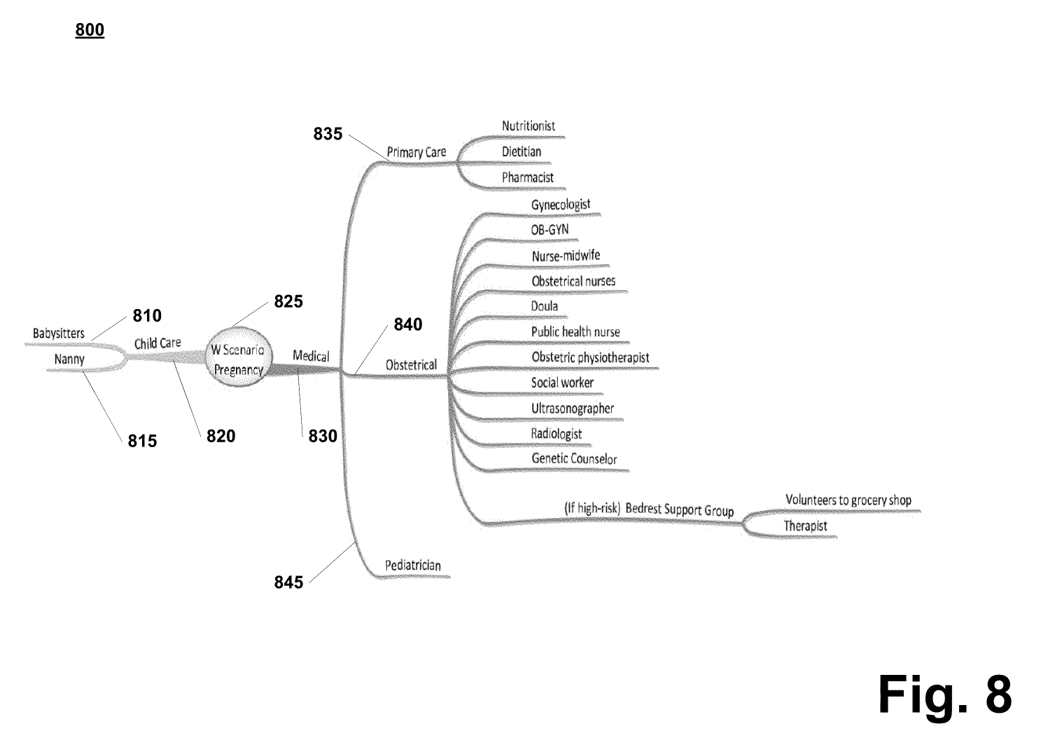

In an illustrative implementation, stored user URN data can comprise a network map (as illustratively described by FIGS. 7 and 8) showing the interplay/associations/connections/degree of separation among and between the inputted URN data elements. In the illustrative implementation, I/RN benchmarking/referral data can comprise data relevant to the management of the illustrative relationships and relationship types described herein as well as benchmarking data that can be used by the participating users 445 to compare their I/RN map with others who have some commonality (e.g., demographics, sociographics, econographics). In the illustrative implementation, interaction scenario data can comprise suggested additional interactions/resource network elements for addition to a participating user's I/RN map based on the occurrence of a near future life event (e.g., the birth of a child, the adoption of a pet, the care of an elderly parent).

In another illustrative operation, and as is shown in FIG. 4, professional services providers (e.g., lawyers, accountants, financial advisors, healthcare professionals) 455 can operatively submit a request for their clients' URN data (i.e., if available and if authorized) using cooperating computing environment 450 over communications network 435 from I/RN data platform 430 to allow the professional service providers 455 better understand the types, numbers, and quality of the I/RN elements of their clients as part of providing requested professional services. By way of example, a trust and estate lawyer can be authorized by his/her client to have access to the client's URN map and associated data such that the trust and estate lawyer can best understand the direct and number of relationships that their client has to better provide counsel on various trust and estate planning issues/matters. Responsive to the request, I/RN data platform 430 can operatively retrieve various URN data for communication (i.e., if available and/or if authorized by the owner of the I/RN data—e.g., participating user 445) to the requesting professional services providers 455 using cooperating computing environment 450 over communications network 435.

FIG. 5 shows exemplary method 500 describing illustrative processing performed by exemplary I/RN data management engine 405 of FIG. 4 in connection with processing data for generating and managing the illustrative I/RN map data described in FIG. 4. As is shown, processing begins at block 505 and proceeds to block 510 where a check is performed to determine whether a participating user has an account. If the check at block 510 indicates that the participating user does have an account, process proceeds to block 525, where the participating user's profile and I/RN stored map data is retrieved. If, however, the check at block 520 indicates that the participating user does not have an account, processing proceeds to block 515 where the user is prompted to input selected profile information. In an illustrative implementation, the selected profile information can comprise demographic data and various preferences for a participating user. From block 515, processing proceeds to block 520 where an inception I/RN map as well as analytic and URN management data are generated for that particular user. In an illustrative implementation, the inception URN map can be generated using one or more map templates that are selected based on the participating user's profile information.

From either block 520 or 525, processing proceeds to block 530 where the retrieved I/RN map or generated I/RN inception map, as well as retrieved/generated analytic, and I/RN management data is displayed to the participating user. A check is then performed at block 535 to determine if the retrieved/generated I/RN map required updating. If the check at block 535 indicates that the I/RN map does not require updating, processing terminates at block 550. If, however, the check at block 535 indicates that the retrieved/generated I/RN map requires updating, processing proceeds to block 540 where one or more I/RN map elements are added/deleted/modified in the retrieved/generated I/RN map. Processing then proceeds to block 545 where the URN referral data (e.g., data providing insights regarding the management of relationships) is retrieved based on the updated I/RN map elements.

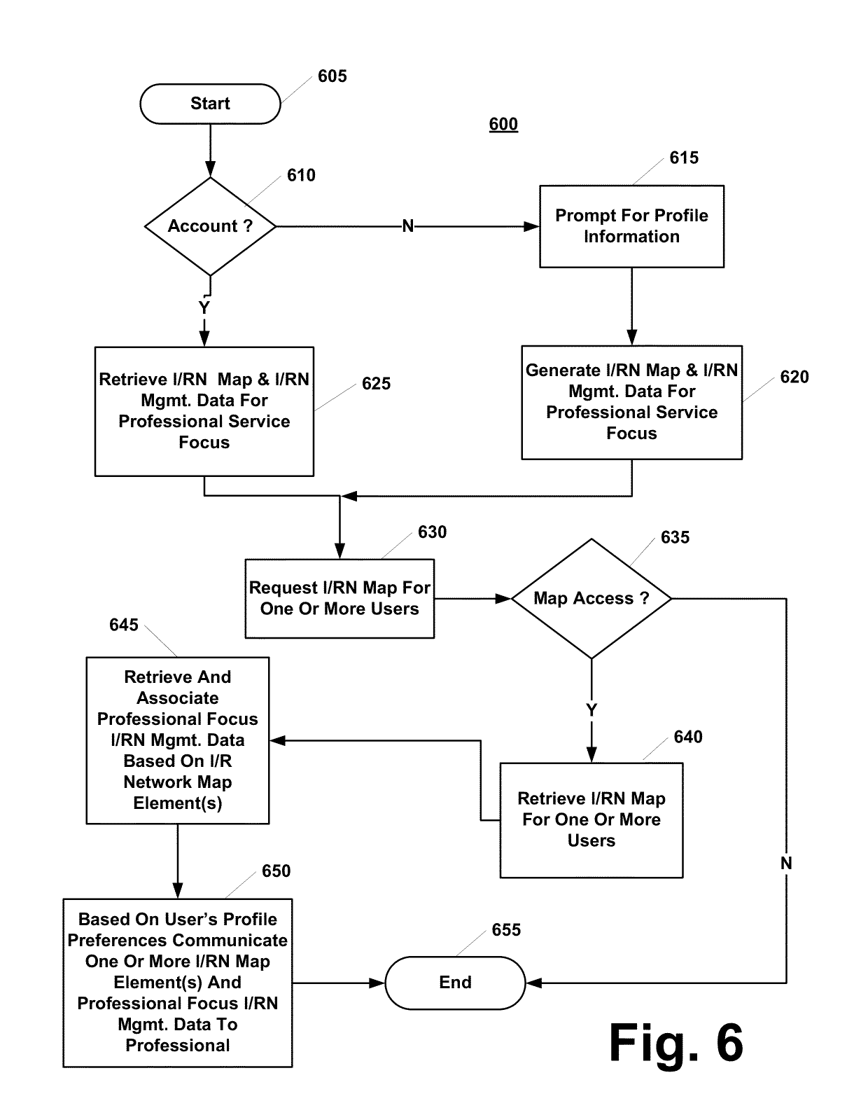

FIG. 6 shows exemplary method 600 describing illustrative processing performed when processing data requests by exemplary I/RN data platform 430 of FIG. 4 for submitted by participating professional service providers as described in FIG. 4. As is shown, processing begins at block 605 and proceeds to block 610 where a check is performed to determine if the participating professional services provider has an account. If the check at block 610 indicates the professional services provider does have an account, processing proceeds to block 625 where URN map and referral data for a selected professional services focus is retrieved. If, however, the check at block 610 indicates that the requesting professional services provider does not have an account, processing proceeds to block 615 where the professional services provider is prompted to input profile information (e.g., demographics, preferences, professional services designation, etc.). From block 615, processing proceeds to block 620 where an I/RN map and I/RN referral data is generated having a selected professional services focus. From either block 620 or 625, processing proceeds to block 630 where an I/RN map is requested for a selected participating user (e.g., client).

At block 630, a check is performed to determine whether the requesting professional services provider has been granted access by the participating user to retrieve the participating user's URN map and I/RN referral data. If the check at block 635 indicates that the requesting professional services provider does not have the requisite authorization, processing terminates at block 655. However, if the check at block 635 indicates that the requesting professional services provider does have the requisite authorization, processing proceeds to block 640 where the participating user's I/RN map is retrieved and then professional focus data is associated based on the URN map elements with the retrieved I/RN map data at block 645 and communicated, in whole or in part, based on the participating user's communication preferences to the requesting professional services provider at block 650. Processing then terminates at block 655.

In an illustrative implementation, a participating user may authorize their psychologist to have access to a portion of their I/RN map to allow their psychologist to gain insight into the client's personal network of relationships and resources. This insight could be invaluable to the psychologist for diagnostic as well as treatment plan purposes for the participating user.

FIG. 7 shows an illustrative graphical representation of an exemplary I/RN map for an exemplary participating user. As is shown, I/RN map 700 comprises numerous URN data types (e.g., family, professional, household) as well as numerous I/RN map elements within each data types that represent one or more I/RN elements (e.g., relationships, resources). As is further shown in FIG. 7, magnification circle 710 magnifies the URN map elements found, by way of example, in the “Professional” I/RN data type 715 of URN map 700. As is shown in magnification circle 710, the “Professional” I/RN data type 715 comprises further sub-types. In the example shown, the “Professional” I/RN data type 715 has two sub-types which can represent more details relative to the original I/RN data type. These two-sub types 720 and 725, as shown, are labeled “Law Practice” and “J's Job”, respectively. Associated with these sub types are various selected I/RN map elements 730, 735, 740, 745, 750, 755, and 760. These I/RN map elements are descriptions of resource network elements for the exemplary participating user for those specific professional I/RN data sub-types. In an illustrative implementation, these resource network elements can comprise functions, activities, operations, and/or personnel that have to be managed in context to the I/RN data type and/or URN data sub-type.

FIG. 8 shows an illustrative graphical representation of an exemplary I/RN scenario 800 that can be presented to a participating user as they build and/or manage their I/RN map. In FIG. 8, the illustrative I/RN scenario that is presented relates to a pregnancy scenario. As is shown, exemplary I/RN scenario comprises various I/RN data types 820 and 830 as well as various I/RN sub-types 810, 815 and 835, 840, and 845 for each I/RN data type respectively that may come to light in the participating user URN map through this life change event 825 (i.e., pregnancy). In the example offered, the participating user is going to have to consider adding various I/RN elements to their I/RN map which logically come with such a life event such as medical personnel (e.g., primary care, obstetrical, and pediatric) as well as possibly child care personnel (e.g., baby sitters and nannies). The herein described systems and methods contemplate the storage of numerous templates that have populated therein suggested URN map elements based on the various I/RN scenarios that a participating user may encounter as life events that can range from graduating high school to marriage to losing a parent and so on.

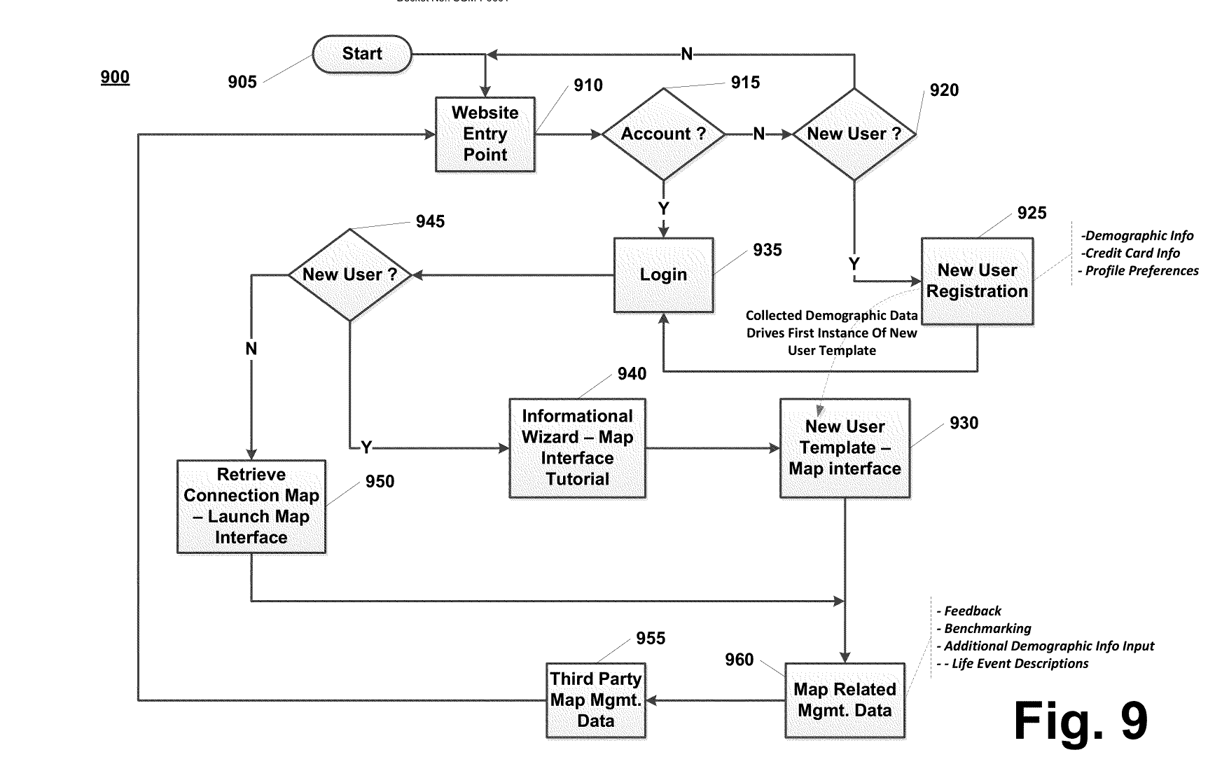

FIG. 9 shows exemplary method 900 performed by exemplary I/RN data platform 430 of FIG. 4 as expressed as part of a web based computing application. As is shown, processing begins at block 905 and proceeds to block 910 where a participating user navigates to a home page acting as the point of entry into the exemplary web-based application. From there processing proceeds to block 910 where a check is performed to determine if the participating user has an account on the platform. If the check at block 910 indicates that the participating user does not have an account, processing proceeds to block 920 where another check is performed to determine if the participating user is a new user to the platform. If the check at block 920 indicates that the user is not a new user, processing reverts back to block 910 and continues from there. However, if the processing at block 920 indicates that the it is a new user, processing proceeds to block 925 where the new user is prompted to input registration information (e.g., demographic information, credit card information, profile preferences, etc.). In an illustrative implementation, the registration information inputted at block 925 can be operatively used as a basis to generate the first instance of the URN map to be generated for the participating user (e.g., if the participating user is married with kids, specific selected inception I/RN templates can be retrieved so as to facilitate the required data input to begin building the I/RN map). Processing from block 925 then proceeds to block 935 and proceeds from there.

If the check at block 915 indicates that the participating user has an account, processing proceeds to block 935 where the participating user is prompted to enter their login credentials. Processing then proceeds to block 945 where a check is performed again to determine if the participating user is a first time user after their first login. If the check at block 945 indicates that it is not a first time user, processing proceeds to block 950 where the user's I/RN map is retrieved and the map interface is launched. After block 950, I/RN referral data is presented at block 960 and third party map management data at block 955 is provided to the participating user. If the check at block 945 indicates that it is a first time user after a first time login, processing proceeds to block 940 where a series of instructions in the form an information wizard are communicated to the participating user to provide instructions regarding the building of the I/RN map using the exemplary user interfaces (as described in FIGS. 10-12). From there processing proceeds to block 930 where a new user URN inception map template (e.g., selected based on the user's profile information) is retrieved for interaction and the map interface (as described in FIGS. 10-12) is launched. From there based on the I/RN inputted map elements (not shown) I/RN referral data is presented at block 960 and third party map management data at block 955 is provided to the participating user.

In an illustrative implementation, I/RN referral data can comprises content concerning the management of relationships/resources (e.g., an article regarding the pay scale for baby sitters for a participating user who has identified she/he has children in the URN map). In the illustrative implementation, the third party map management data can comprise suggested content from professional service providers regarding specific operations, features, activities, efforts, etc. regarding one or more inputted I/RN map elements (e.g., a legal news alert regarding investment properties for a participating user who included a housekeeper associated with the participating user's vacation villa). Processing then proceeds from block 955 and reverts back to block 910 and continues from there. However, if the check at block 945 indicates that it is not a user, the I/RN map is retrieved for the participating user and the map interface is launched as described in FIGS. 10-12.

FIG. 10 is a block diagram of an exemplary interactive graphical user interface (IGUI) for use by a participating user on a cooperating computing environment to input, retrieve, update, and navigate I/RN map data from/to exemplary I/RN data platform 430 of FIG. 4. As is shown, I/RN map interface 1000 comprises data window 1002 having various navigations controls 1006 and 1008 that provide specific operations and features such as 1004, 1010, and 1012 (e.g., create new I/RN data types, retrieve I/RN scenarios, retrieve I/RN referral data). It is appreciated that the inventive concepts described herein are not limited to any specific navigation control mechanism but can incorporate best of breed navigation controls including drag and drop navigation controls. In the I/RN map interface, data window 1002 is operable to graphically display one or more URN data types 1007, 1014, 1018, 1022 that can have associated contextual data also displayed such as the number of elements 1016 and 1020 for each URN data type. As is further shown in FIG. 10, upon the interaction with one or more of the listed I/RN data types 1007, 1014, 1018, 1022, operatively, a second window 1028 that allows the participating user to manage the I/RN elements and provide additional descriptive and contextual data for the I/RN map element.

As is shown, second window 1028 can comprise navigation control areas 1030 and 1026 that can comprise various operations and features such as 1030 and 1038. In the illustrative implementation, the operations and features can allow a participating user to add, delete, modify, manage URN map elements as well as enter descriptive information regarding each of the I/RN map elements as shown as a third window dialog 1032 containing various data 1034 and 1036 that can be variably inputted using various data input fields (e.g., comment box, drop down list, radio buttons).

In an illustrative implantation, URN map interface 1000 can be operative to display an inception I/RN map. In this context, an inception I/RN map can have pre-populated I/RN data types that are selected based on the participating user's profile information such that, by way of example, a participating user who is employed, married with children, and is a national guard reservist could be presented with an I/RN inception map having URN data types for family, profession, and military designations.

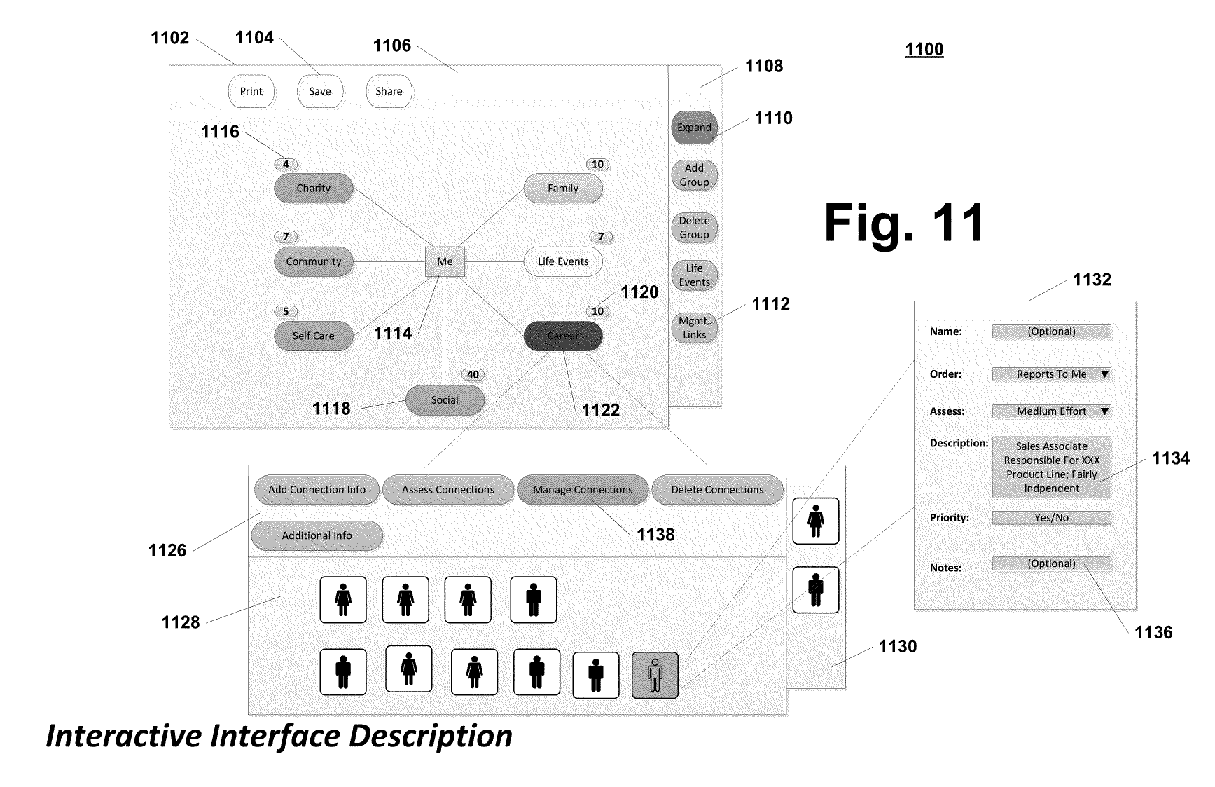

FIG. 11 is a block diagram of an exemplary interactive graphical user interface (IGUI) for use by a participating user on a cooperating computing environment to input, retrieve, update, and navigate I/RN map data from/to exemplary I/RN data platform 430 of FIG. 4. As is shown, I/RN map interface 1100 comprises data window 1102 having various navigations controls 1106 and 1108 that provide specific operations and features such as 1104, 1110, and 1112 (e.g., create new I/RN data types, retrieve I/RN scenarios, retrieve I/RN referral data, etc.). It is appreciated that the inventive concepts described herein are not limited to any specific navigation control mechanism but can incorporate best of breed navigation controls including drag and drop navigation controls. In the I/RN map interface, data window 1102 is operable to graphically display one or more URN data types 1114, 1118, 1122 that can have associated contextual data also displayed such as the number of elements 1116 and 1120 for each URN data type. As is further shown in FIG. 11, upon the interaction with one or more of the listed I/RN data types 1114, 1118, 1122, operatively, a second window 1128 that allows the participating user to manage the I/RN elements and provide additional descriptive and contextual data for the I/RN map element.

As is shown, second window 1128 can comprise navigation control areas 1130 and 1126 that can comprise various operations and features such as 1130 and 1138. In the illustrative implementation, the operations and features can allow a participating user to add, delete, modify, manage URN map elements as well as enter descriptive information regarding each of the I/RN map elements as shown as a third window dialog 1132 containing various data 1134 and 1136 that can be variably inputted using various data input fields (e.g., comment box, drop down list, radio buttons, etc.).

In an illustrative implantation, URN map interface 1100 can be operative to display and navigate an existing/retrieved URN map. In this context, the retrieved I/RN map comprises historical I/RN data types that the participating user has previously inputted and which can be modified through the use of navigation controls of URN map interface 1100.

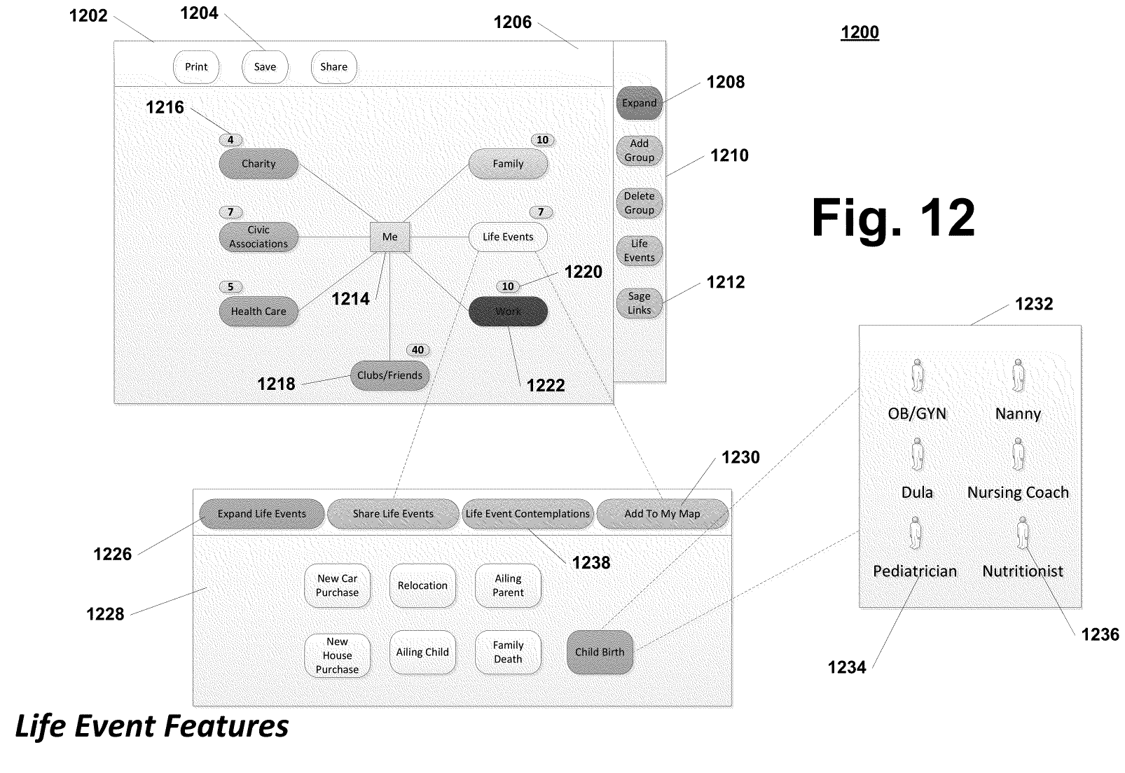

FIG. 12 is a block diagram of an exemplary interactive graphical user interface (IGUI) for use by a participating user on a cooperating computing environment to input, retrieve, update, and navigate I/RN map data from/to exemplary I/RN data platform 430 of FIG. 4. As is shown, I/RN map interface 1200 comprises data window 1202 having various navigations controls 1206 and 1208 that provide specific operations and features such as 1204, 1210, and 1212 (e.g., create new I/RN data types, retrieve I/RN scenarios, retrieve I/RN referral data, etc.). It is appreciated that the inventive concepts described herein are not limited to any specific navigation control mechanism but can incorporate best of breed navigation controls including drag and drop navigation controls. In the I/RN map interface, data window 1202 is operable to graphically display one or more URN data types 1214, 1218, 1222 that can have associated contextual data also displayed such as the number of elements 1216 and 1220 for each URN data type. As is further shown in FIG. 12, upon the interaction with a life event data type 1220, operatively, a second window 1228 that allows the participating user to select from various URN scenarios to allow the participating user to review suggested I/RN map elements associated with the selected life event, manage the suggested URN elements and provide additional descriptive and contextual data for the I/RN map element.

As is shown, second window 1228 can comprise navigation control area 1226 that can comprise various operations and features such as 1230 and 1238. In the illustrative implementation, the operations and features can allow a participating user to add, delete, modify, manage URN map elements as well as enter descriptive information regarding each of the I/RN map elements as shown as a third window dialog 1232 containing various suggested URN scenario map elements 1234 and 1236 that can be added to the participating user's URN map using navigation controls 1230.

In an illustrative implantation, URN map interface 1200 can be operative to display and navigate an existing/retrieved URN map and suggested URN scenario map elements. In this context, the retrieved URN map comprises historical I/RN data types that the participating user has previously inputted and which can be modified through the use of navigation controls of I/RN map interface 1200. By way of example, as is shown in FIG. 12, the life event data type can be selected which then retrieves various URN scenarios such as child birth. In this context, the child birth I/RN scenario has various selected URN map elements to which it is already associated including, for example, nannies, nursing coaches, etc.

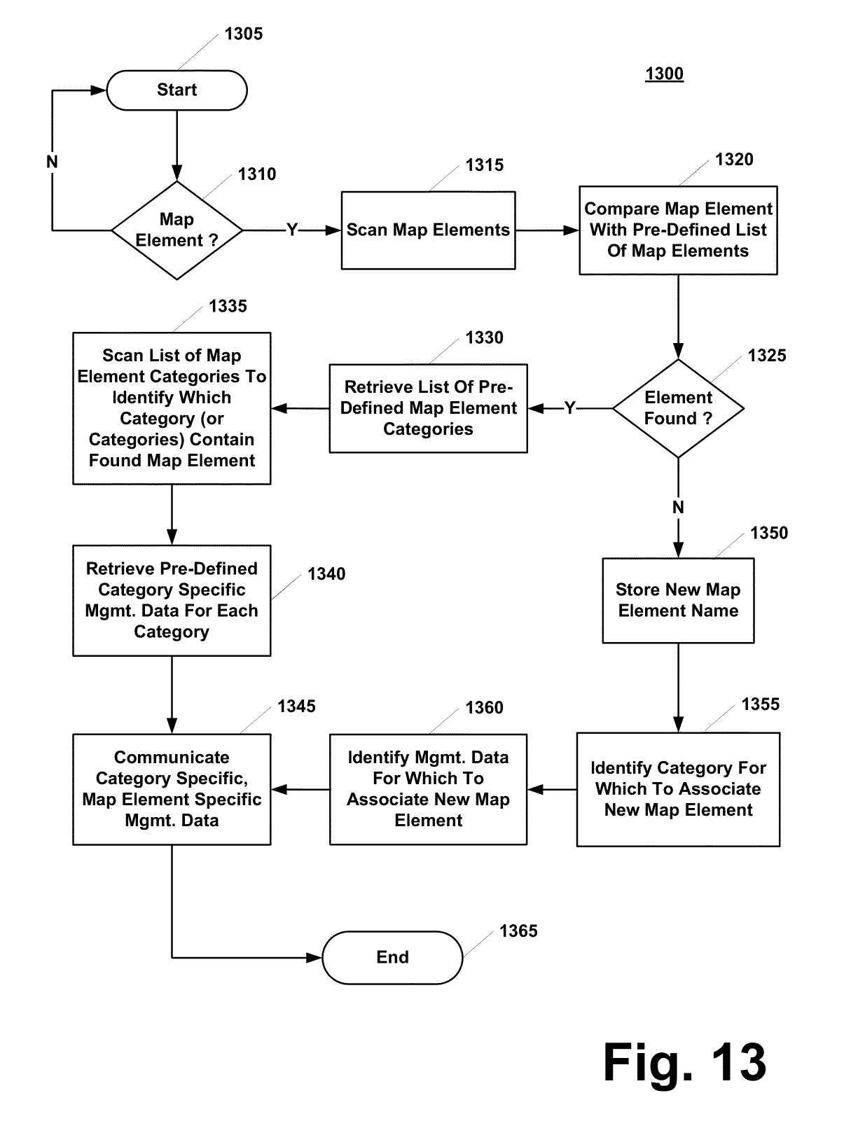

FIG. 13 is a flow diagram of exemplary method 1300 for use by exemplary I/RN data platform 430 of FIG. 4 in processing inputted I/RN map data to select specific I/RN referral data. As is shown, processing begins at block 1305 and proceeds to block 1310 where a check is performed to determine if there is a map element in the I/RN map. If the check at block 1310 indicates that there is not a map element present, processing reverts back to block 1305 and proceeds from there. However, if the check at block 1310 indicates that there is a map element, processing proceeds to block 1315 where the I/RN map's map elements are scanned and compared against a list of pre-defined map elements at block 1320. From there a check is performed at block 1325 to determine if the scanned map element is found on the pre-defined list. If the comparison proves true, processing proceeds to block 1330 where a list of pre-defined I/RN map data types are retrieved and scanned at block 1335 to determine which I/RN data type to associate the inputted I/RN map element. From there, I/RN data type specific referral data is retrieved at block 1340 and communicated at block 1345 to the participating user. Processing then terminates at block 1365.

However, if the check at block 1325 indicates that the inputted map element is not found in the list of pre-defined map elements, processing proceeds to block 1350 where the new map element name is stored. From there processing proceeds to block 1355 where the URN category is identified for which to associate to the newly inputted map element. From there processing proceeds to block 1360 where I/RN referral data is identified for which to associate to the newly inputted map element. Processing proceeds to block 1345 and continues from there.

In an illustrative operation, method 1300 can be described as receiving data representative of a plurality of URN elements, where each of the URN elements comprises a present, past, and/or future personal relationship, professional relationship, relationships with a pet, relationships with an object, spiritual relationship, social relationship or other resource. From there, at least one I/RN data type is selected based on at least one characteristic of the received I/RN element and is associated with one of the plurality of received I/RN elements. In the illustrative operation, method 1300 can also generate at least one I/RN contextual data association, where each of the at least one I/RN contextual data associations define an association between at least two of the plurality of I/RN elements based on at least one characteristic of each of the at least two of the plurality of I/RN elements. In an illustrative implementation, the one or more characteristics of the URN elements can comprise data representative of the degree of separation between one or more I/RN elements along the tree of consanguinity, data representative of the placement of an I/RN element on a selected organizational chart, data representative of the type of relationship represented by the URN element data, data representative of the age of the relationship represented by the I/RN element data, data representative of the demographics of the I/RN element comprising age data, gender data, income data, location data, education data, and career data. By way of example, an I/RN data type can comprise a category of relationships (e.g., family, work, faith), an URN map element can comprises people that would be present such relationship categories (e.g., brother, sister, boss, priest), and a contextual data association can comprise the number of elements in any given category. In the illustrative operation, a graphical representation can then be generated that shows the plurality of URN elements, the at least one URN contextual data association and the at least one characteristics of the plurality of I/RN elements for which an association is defined.

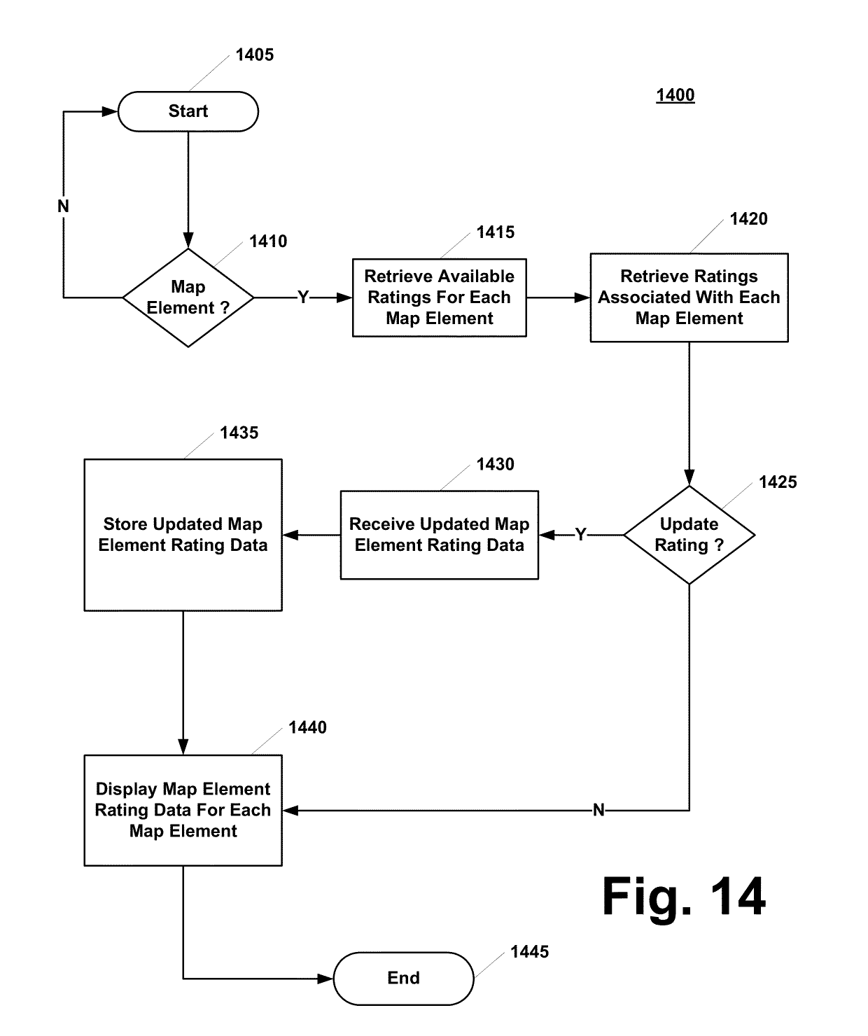

FIG. 14 shows exemplary method 1400 for use by exemplary URN data platform 430 of FIG. 4 in processing rating data for I/RN map elements. As is shown, processing begins at block 1405 and proceeds to block 1410 where a check is performed to determine if there is a map element. If a map element is not present, processing reverts back to block 1405 and continues from there. If there is a map element present, processing proceeds to block 1415 where the available ratings for the map element is retrieved as well as any historical map element ratings that may have been associated with the map element are retrieved at block 1420. A check is then performed at block 1425 to determine if the retrieved map element rating requires update. If an update is required, processing proceeds to block 1430 where updated map element data is received. The updated map element rating data is stored at block 1435 and communicated for display at block 1440. However, if the check at block 1425 indicates that a rating update is not requested, processing proceeds to block 1440. Processing then terminates at block 1445.

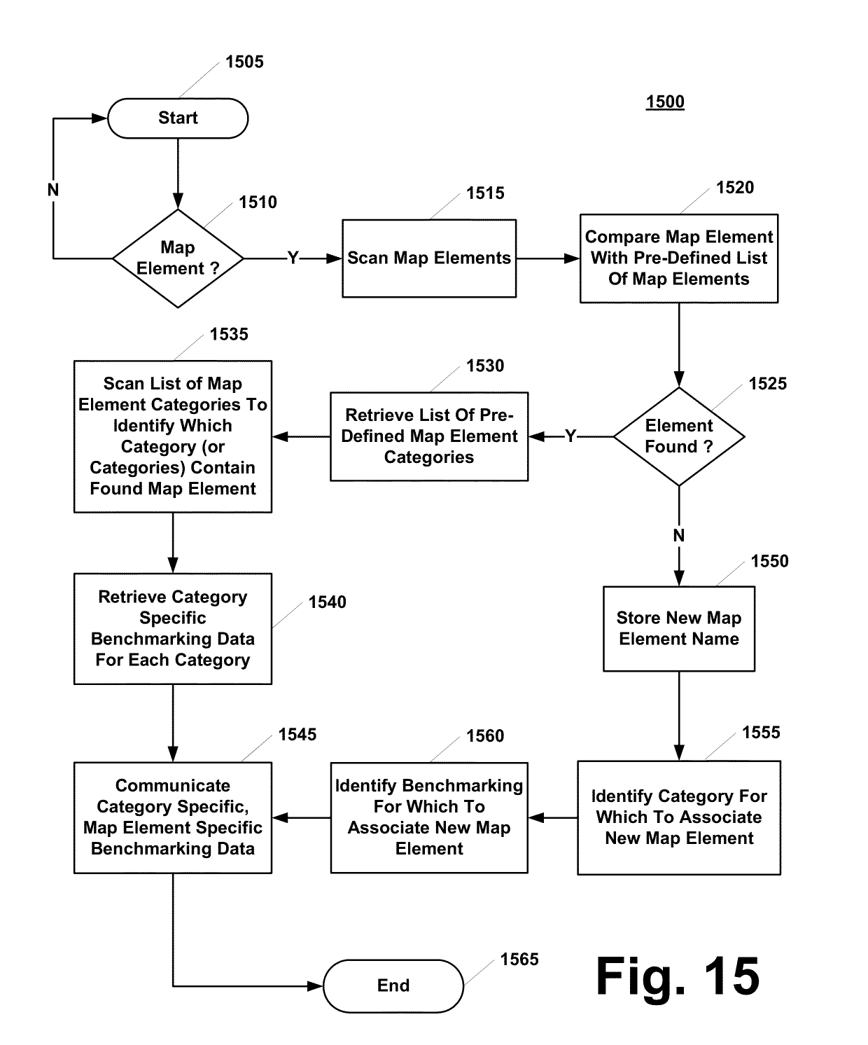

FIG. 15 is a flow diagram of exemplary method 1500 for use by exemplary I/RN data platform 430 of FIG. 4 in processing inputted I/RN map data to select specific I/RN benchmarking data. As is shown, processing begins at block 1505 and proceeds to block 1510 where a check is performed to determine if there is a map element in the I/RN map. If the check at block 1510 indicates that there is not a map element present, processing reverts back to block 1415 and proceeds from there. However, if the check at block 1510 indicates that there is a map element, processing proceeds to block 1515 where the I/RN map's map elements are scanned and compared against a list of pre-defined map elements at block 1520. From there a check is performed at block 1525 to determine if the scanned map element is found on the pre-defined list. If the comparison proves true, processing proceeds to block 1530 where a list of pre-defined I/RN map data types are retrieved and scanned at block 1535 to determine which I/RN data type to associate the inputted I/RN map element. From there, URN data type specific benchmarking data is retrieved at block 1540 and communicated at block 1355 to the participating user. Processing then terminates at block 1365.

However, if the check at block 1525 indicates that the inputted map element is not found in the list of pre-defined map elements, processing proceeds to block 1550 where the new map element name is stored. From there processing proceeds to block 1555 where the URN data type is identified for which to associate the newly inputted map element. From there processing proceeds to block 1560 where I/RN benchmarking data is identified for which to associate to the newly inputted map element. Processing proceeds to block 1545 and continues from there. Processing then terminates at block 1565.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both non-wireless and wireless computer environments and including cell phones and video phones), partial computing environments, and real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

1. A system for aggregating and managing data, comprising:
a computing processor; and
computing memory communicatively coupled with the computing processor, the computing memory having stored therein instructions that, if executed by the computing processor, cause the computing processor to perform operations comprising:
(a) receiving data representative of a plurality of interaction/resource network elements, each of the interaction/resource network elements comprising a relationship or resource;
(b) selecting at least one interaction/resource network data type based on at least one characteristic of one of the plurality of received interaction/resource network elements and associating the at least one interaction/resource network data type with one of the plurality of received interaction/resource network elements;
(c) generating at least one interaction/resource network contextual data association, each of the at least one interaction/resource network contextual data associations defining an association between at least two of the plurality of interaction/resource network elements based on at least one characteristic of each of the at least two of the plurality of interaction/resource network elements;
(d) generating a graphical representation that shows the plurality of interaction/resource network elements, the at least one interaction/resource network contextual data association and the at least one characteristics of the plurality of interaction/resource network elements for which an association is defined in step (c);
(e) retrieving data representative of interaction/resource network referral data from one or more cooperating data stores based on the at least one interaction/resource network data type selected in step; and
(f) generating, based on the interaction/resource network data types and the interaction/resource network referral data, one or more suggested future personal relationships, professional relationships, relationships with pets, relationships with objects, spiritual relationships, and social relationships, wherein the interaction/resource network data types comprises data representative of one or more categories of relationships comprising present and past personal relationships, professional relationships, relationships with pets, relationships with objects, spiritual relationships, social relationships and life events.

2. The system as recited in claim 1, further comprising:
(g) communicating the generated graphical representation and interaction/resource network referral data to one or more cooperating computing environments.

3. The sys em as recited in claim 1, wherein the graphical representation comprises an interaction/resource network element map.

4-5. (canceled)

6. The system as recited in claim 1, wherein each of the at least one characteristic of each of the at least two of the plurality of interaction/resource network elements comprises data representative of a degree of separation between each of the at least two of the plurality of interaction/resource network elements along a tree of consanguinity, data representative of placement of one of the plurality of interaction/resource network elements on a selected organizational chart, data representative of a type of relationship or resource represented by one of the of plurality of interaction/resource network elements, data representative of an age of a relationship represented by one of the plurality of interaction/resource network elements, or data representative of a demographic of one of the plurality of interaction/resource network elements, the demographic comprising age data, gender data, income data, location data, education data, and/or career data.

7. The system as recited in claim 1, further comprising:
(h) retrieving at least one interaction scenario from one or more cooperating data stores based on the at least one interaction/resource network contextual association generated in step (c), each of the at least one interaction scenario comprising at least one interaction/resource network data type; and
(i) including each of the at least one interaction/resource network data type in the graphical representation generated in step (d).

8. The system as recited in claim 1, wherein each of the at least one interaction/resource network element received in step a) is received from one or more computing environments operable to execute an interactive graphical user interface (IGUI) that is operable to interactively input an interaction/resource network element.

9. (canceled)

10. The system as recited in claim 2, wherein the interaction/resource network referral data retrieved in step (e) comprises data representative of content regarding management of one or more relationships, content regarding management of one or more relationship types, or content regarding one or more professional service providers.

11. The system as recited in claim 2, wherein the at least one interaction/resource network contextual association comprises data representative of a degree of separation between the at least two of the plurality of interactions/resource network elements.

12. The system as recited in claim 1, wherein the relationship or resource comprises a past, present or suggested future personal relationship, professional relationship, relationships with a pet, relationship with an object, spiritual relationship, or social relationship.

13. A method for aggregating and managing data, comprising:
(a) receiving data representative of a plurality of interaction/resource network elements, each of the interaction/resource network elements comprising a relationship or resource;
(b) selecting at least one interaction/resource network data type based on at least one characteristic of one of the plurality of received interaction/resource network elements and associating the at least one interaction/resource network data type with one of the plurality of received interaction/resource network elements; and
(c) generating at least one interaction/resource network contextual data association, each of the at least one interaction/resource network contextual data associations defining an association between at least two of the plurality of interaction/resource network elements based on at least one characteristic of each of the at least two of the plurality of interaction/resource network elements;
(d) generating a graphical representation that shows the plurality of interaction/resource network elements, the at least one interaction/resource network contextual data association and the at least one characteristics of the plurality of interaction/resource network elements for which an association is defined in step (c);
(e) retrieving data representative of interaction/resource network referral data from one or more cooperating data stores based on the at least one interaction/resource network data type selected in step (b); and
(f) generating, based on the interaction/resource network data types and the interaction/resource network referral data, one or more suggested future personal relationships, professional relationships, relationships with pets, relationships with objects, spiritual relationships, and social relationships, wherein the interaction/resource network data types comprises data representative of one or more categories of relationships comprising present and past personal relationships, professional relations, relationships with pets, relationships with objects, spiritual relationships, social relationships and life events.

14. The method as recited in claim 13, further comprising:
(f) communicating the generated graphical representation and interaction/resource network referral data to one or more cooperating computing environments.

15-17. (canceled)

18. The method as recited in claim 13, wherein each of the at least one characteristic of each of the at least two of the plurality of interaction/resource network elements comprises data representative of a degree of separation between each of the at least two of the plurality of interaction/resource network elements along a tree of consanguinity, data representative of placement of one of the plurality of interaction/resource network elements on a selected organizational chart, data representative of a type of relationship or resource represented by one of the of plurality of interaction/resource network elements, data representative of an age of a relationship represented by one of the plurality of interaction/resource network elements, or data representative of a demographic of one of the plurality of interaction/resource network elements, the demographic comprising age data, gender data, income data, location data, education data, and/or career data.

19. The method as recited in claim 13, further comprising:
(g) retrieving at least one interaction scenario from one or more cooperating data stores based on the at least one interaction/resource network contextual association generated in step (c), each of the at least one interaction scenario comprising at least one interaction/resource network data type; and
(h) including each of the at least one interaction/resource network data type in the graphical representation generated in step (d).

20. The method as recited in claim 13, wherein each of the at least one interaction/resource network element received in step (a) is received from one or more computing environments operable to execute an interactive graphical user interface (IGUI) that is operable to interactively input an interaction/resource network element.

21. The method as recited in claim 13, wherein the interaction/resource network data types comprises data representative of one or more categories of relationships comprising present, past, and/or suggested future personal relationships, professional relationships, relationships with pets, relationships with objects, spiritual relationships, and social relationships.

22. The method as recited in claim 14, wherein the interaction/resource network referral data retrieved in step (e) comprises data representative of content regarding management of one or more relationships, content regarding management of one or more relationship types, or content regarding one or more professional service providers.

23. The method as recited in claim 14, wherein the at least one interaction/resource network contextual association comprises data representative of a degree of separation between the at least two of the plurality of interactions/resource network elements.

24. The method as recited in claim 13, further comprising generating contextual interaction/resource network data comprising data representative of the degree of separation between one or more interactions/resource network elements.

25. (canceled)
